(19) United States
(12) Patent Application Publication
(10) Pub. No.: US 2024/0127112 A1
(43) Pub. Date: Apr. 18, 2024

(54) CODE RADAR

(71) Applicant: Microsoft Technology Licensing, LLC, Redmond, WA (US)

(72) Inventors: Albert ZIEGLER, Uppsala (SE); Amelia Mein-rou WATTENBERGER, Oakland, CA (US)

(21) Appl. No.: 18/168,229

(22) Filed: Feb. 13, 2023

Related U.S. Application Data
(60) Provisional application No. 63/416,258, filed on Oct. 14, 2022.

(51) Int. Cl. G06N 20/00

(52) U.S. Cl. CPC G06N 20/00

(57) ABSTRACT

Using a language model attention matrix to facilitate a “code radar” source code navigation experience that highlights related source code locations. A computer system identifies a first source code location within source code that is displayed at a code editor user interface (UI). From a set of mappings generated based on a language model attention matrix, the computer system identifies a second source code location as being related to the first source code location. Concurrent with presenting the first source code location in the code editor UI, the computer system presents a related source code navigation experience, which includes both (i) presenting the second source code location in the code editor UI, and (ii) presenting a visual indication that the second source code location is related to the first source code location. Some embodiments include generating the set of mappings based on a language model attention matrix.

### CROSS-REFERENCE TO RELATED APPLICATIONS

This application claims priority to, and the benefit of, U.S. Provisional Patent Application Ser. No. 63/416,258, filed Oct. 14, 2022 and entitled “CODE RADAR,” the contents of which are incorporated by reference herein in their entirety.

### BACKGROUND OF THE INVENTION

In computing, artificial intelligence (AI) refers to the capability of a computer system to mimic human cognitive functions such as learning and problem-solving. One application of AI is machine learning (ML), which creates and uses mathematical models of data. ML algorithms build a model based on sample data, known as training data, in order to make predictions or decisions without being explicitly programmed to do so.

One application of AI and ML is the creation of language synthesis (or generation) models, often in the form of a large language model (LLM). As an example, an LLM may be tens of gigabytes in size, and be trained on data at the petabyte scale. Once trained, language synthesis models consume an input “prompt” comprising a portion of text, along with a requested prediction length, and synthesize a prediction of up to the requested length for how to continue that text. When trained using computer languages, language synthesis models (e.g., code synthesis models) can be used to synthesize code based on an input prompt. In one application, code synthesis models are integrated into a source code editor, such as within an integrated development environment (IDE), to provide AI/ML-based code completion suggestions that can, for example, provide suggestions for how to complete entire functions. For example, GITHUB COPILOT is an AI pair programmer that helps developers write code faster and with less work, by drawing context from comments and code to craft input prompts that are input to a language model, such as CODEX from OPENAI, to suggest individual lines and whole functions.

The subject matter claimed herein is not limited to embodiments that solve any disadvantages or that operate only in environments such as those described above. Rather, this background is only provided to illustrate one example technology area where some embodiments described herein may be practiced.

### SUMMARY OF THE INVENTION

In some aspects, the techniques described herein relate to methods, systems, and computer program products which include: identifying a first source code location, the first source code location being within source code that is displayed at a code editor user interface (UI); from a set of mappings generated based on a language model attention matrix, identifying a set of one or more source code locations as being related to the first source code location, the set of one or more source code locations including a second source code location; and concurrent with presenting the first source code location in the code editor UI, presenting a related source code navigation experience, including: presenting the second source code location in the code editor UI; and presenting a visual indication that the second source code location is related to the first source code location.

In some aspects, the techniques described herein relate to methods, systems, and computer program products which include: accessing an attention matrix that is produced as part of generation of a language model prediction; processing the attention matrix to generate a set of mappings, each mapping in the set of mappings associating a subject token within source code to a set of one or more related tokens within the source code, each related token being estimated to relate to the subject token; and applying a distance function to one or more mappings in the set of mappings including, for a mapping of the one or more mappings, weighting each related token based on its distance from its subject token within the source code.

In some aspects, the techniques described herein relate to methods, systems, and computer program products which include: generating a set of mappings of related source code locations based on a language model attention matrix; identifying a first source code location, the first source code location being within source code that is displayed at a code editor UI; from the set of mappings, identifying a set of one or more source code locations as being related to the first source code location, the set of one or more source code locations including a second source code location; and concurrent with presenting the first source code location in the code editor UI, presenting a related source code navigation experience, including: presenting the second source code location in the code editor UI; and presenting a visual indication that the second source code location is related to the first source code location.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 illustrates an example computer architecture that uses a language model attention matrix to facilitate a “code radar” source code navigation experience that highlights one or more related source code locations;

FIG. 2 illustrates a code sample, for use in connection with FIGS. 3A-3F;

FIGS. 3A to 3F illustrate examples of a code radar user interface (UI);

FIG. 4 illustrates a flow chart of an example method for providing a related source code navigation experience within a code editor UI; and

FIG. 5 illustrates a flow chart of an example method for generating a set of mappings of related source code locations based on a language model attention matrix.

### DETAILED DESCRIPTION OF THE INVENTION

Contemporary large language models (LLMs), such as CODEX from OPENAI, are based on a “self-attention” architecture that automatically draws global dependencies between model inputs and model outputs. In embodiments, when an LLM is used as a code synthesis model, the subject code is divided into different tokens (e.g., a chunk of characters, typically 2-6 characters). A different LLM “observer” is assigned to each of these tokens, with that observer becoming an expert on that token. In particular, for each token, a corresponding observer builds up observer state for that token at each layer of the LLM. In embodiments, the observer state for a given token at one layer in the LLM feeds into the observer state for that token at the next layer of the LLM. In some examples, an LLM has tens of these layers (e.g., presently 32 layers, in the case of CODEX), though there is no architectural limit on the number of layers that could be used. In general, a number of layers used for an LLM affects an amount of computing resources (e.g., processing, memory, and/or storage) needed to train and use the LLM.

In self-attention architectures, observers communicate with one another at each layer of the LLM, establishing relationships among the observers. For example, a given observer offers information about its state, and if another observer can use that information those observers are matched (or at least partially matched). Observers that are matched more frequently have a stronger match strength, and observers that are matched less frequently have a lesser match strength. Thus, in embodiments, the “match strength” between two observers is based on a total frequency of all matches between those two observers. When there is a stronger match strength between two given observers, those observers' tokens are likely more relevant to one another. For code synthesis models, this means that the code position of one observer's token is relevant to the code position of another observer's token. Relevance could mean that one code location contains documentation relevant to another code location, that one code location contains an assignment to a variable at another code location, that one code location contains a declaration of a function used at another code location, etc.

In some implementations, outputs of self-attention algorithms are recorded as one or more attention matrices, which are generally multi-dimensional (e.g., four-dimensional) tensors that represent a strength of matches in each layer of an LLM. Attention matrices are often costly to compute (e.g., in terms of processing resources, in terms of energy resources). Attention matrices are generally produced as a side-product of use of LLMs. For example, as part of generating source code completions for an artificial intelligence (AI) pair programmer, such as when CODEX generates completions for GITHUB COPILOT. However, in conventional usage of LLMs as language (e.g., code) synthesis models, these attention matrices are discarded after generating a prediction.

Rather than discarding attention matrices, as is conventional, the embodiments herein utilize attention matrices, such as those produced as part of generating source code completions, to facilitate an AI-driven source code navigation experience (e.g., as part of an integrated development environment (IDE), within a code editor). Embodiments derive mappings (e.g., a graph), of token relevance from attention matrices based on the strength of matches between observers, as captured by the attention matrices. Mappings may be one-to-one (e.g., one token maps to another token) and/or one-to-many (e.g., one token maps to multiple tokens representing a logical unit, such as a line of code). Additionally, mappings may be bidirectional (e.g., a first token maps to a second token, and the second token also maps to the first token), and/or may be unidirectional (e.g., a first token maps to a second token, but the second token does not map to the first token).

Based on these mappings, embodiments provide a source code navigation experience via a user interface (UI) (e.g., pane, window, etc.), referred to herein as a “code radar” UI. The code radar UI provides relevant context for a code location that a user is currently focused on in an editor UI (e.g., code corresponding to a cursor location within the editor UI, code that has been selected within the editor UI). In embodiments, the code radar UI aims to provide a summary of one or more other code locations that a user's eyes would naturally flow to, based on the code location that the user is currently focused on. For example, if a user is focused on a variable, the code radar UI may show a code location where the variable is declared, code location(s) where the variable is assigned, code location(s) where the variable is documented, and the like. In embodiments, the code radar UI provides one or more related code locations as sections of code (e.g., multiple lines, including context surrounding the code location of interest) as excerpts. In some embodiments, these excerpts emphasize more relevant portions, and deemphasize or even elide less relevant portions. In some embodiments, based on static analysis, the code radar UI also provides an indication of why a given code location may be relevant.

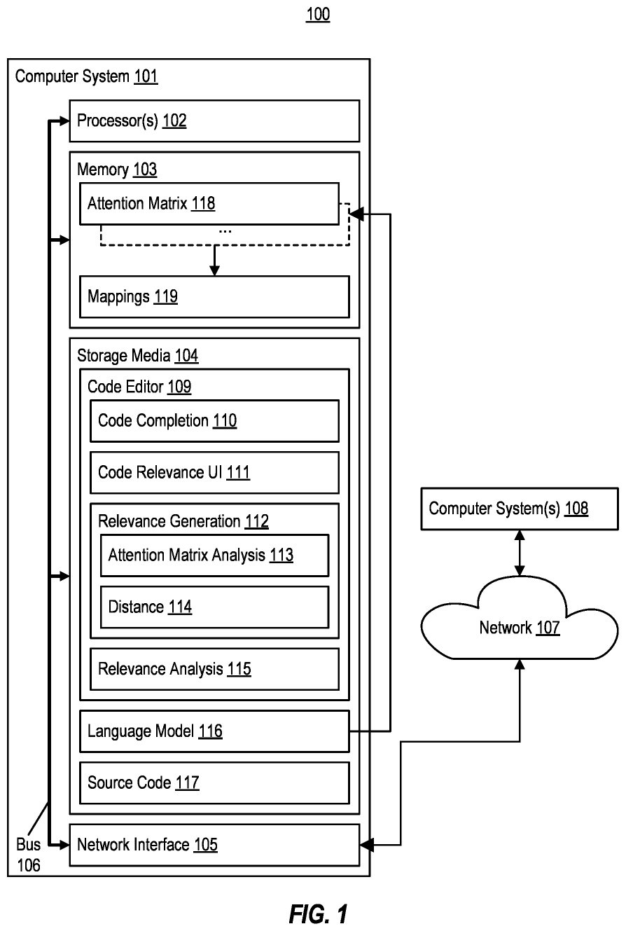

FIG. 1 illustrates an example computer architecture 100 that facilitates using a language model attention matrix to facilitate a code radar source code navigation experience that highlights one or more related source code locations. As shown, computer architecture 100 includes a computer system 101 comprising processor(s) 102 (e.g., a single processor, or a plurality of processors), memory 103 (e.g., system or main memory), storage media 104 (e.g., a single computer-readable storage medium, or a plurality of computer-readable storage media), all interconnected by a bus 106. As shown, computer system 101 may also include a network interface 105 (e.g., one or more network interface cards) for interconnecting (via a network 107) to computer system(s) 108 (e.g., a single computer system, or a plurality of computer systems).

While, for brevity, embodiments are described with connection to executable instructions, data, and operations at computer system 101, some embodiments operate in a distributed manner between computer system 101 and computer system(s) 108. Thus, for example, at least a portion of the executable instructions, data, and/or operations described herein could alternatively be performed at computer system(s) 108.

Storage media 104 is illustrated as storing computer-executable instructions implementing a code editor 109, and as also storing a language model 116 and source code 117 (e.g., a single source code file, or a plurality of source code files). In embodiments, code editor 109 is an application, such as an integrated development environment (IDE), for code development. Thus, code editor 109 is capable of creating and editing files within source code 117. In embodiments, code editor 109 utilizes language model 116 to assist in code development. For example, code editor 109 includes a code completion component 110 that utilizes a code synthesis model, such as language model 116, to provide suggested code completions at a code editor UI. In one example, language model 116 is an LLM, such as CODEX.

As discussed, attention matrices are generally produced as a side-product of use of LLMs, such as when generating source code completions for use by code completion component 110. Thus, FIG. 1 illustrates an attention matrix 118 (or a plurality of attention matrices) within memory 103. An arrow connecting language model 116 to attention matrix 118 indicates that attention matrix 118 is produced as a result of operation of language model 116 (e.g., based on operation of code completion component 110). As will be appreciated by one of ordinary skill in the art, attention matrix 118 could additionally, or alternatively, be stored in storage media 104, or even at computer system(s) 108. As also discussed, in conventional usage of LLMs as language synthesis models, attention matrices are discarded after generating a prediction. However, rather than discarding attention matrix 118, embodiments use attention matrix 118 to drive a novel and unique source code navigation experience (referred to herein more simply as code radar) that aims to guide a user's eyes to relevant code locations, based on code the user is currently focused on within code editor 109.

Storage media 104 is illustrated as including a relevance generation component 112. In embodiments, using attention matrix analysis component 113, relevance generation component 112 generates a set of mappings from attention matrix 118. Thus, memory 103 is illustrated as including mappings 119, with an arrow that extends from attention matrix 118 to mappings 119 indicating that mappings 119 are derived from attention matrix 118. As will be appreciated by one of ordinary skill in the art, mappings 119 could additionally, or alternatively, be stored in storage media 104, or even at computer system(s) 108.

In some embodiments, attention matrix analysis component 113 generates mappings using one or more attention matrix postprocessing approaches that condense an attention tensor A to a vector a. In embodiments, one approach is based on computing an “attention mean,” which takes the average attention weight for each position along the two dimensions of different layers l and attention heads h to compensate the extreme values with each other and extract a smoother signal. This step outputs a matrix B with shape (n,n) where each element B_{(i,j)} is the average attention weight of the token in the prompt to the j^{th} token in the prompt. In embodiments, this is a lower triangular matrix due to the masked nature of self-attention. Since the positions above a main diagonal are all zeros, embodiments compute the mean of each column, excluding the zeros to avoid penalizing more recent tokens with less followers. Since each column can be seen as the attention given to j^{th} token by its “followers” this step is referred to as “mean of followers,” which produces a token-level visual attention a vector. To convert it to a character level vector, embodiments divide the attention weight on a single token in equal shares among all its characters. In embodiments, the attention mean approach computes the mean among all the L layers of and H attention heads as shown in Equation 1:

$${g}_{mean} = \frac{1}{L * H} {\sum }_{l = 1}^{L} {\sum }_{h = 1}^{H} {A}_{l , h} \qquad Equation 1$$

In embodiments, another approach to condense an attention tensor A to a vector a is based on computing an “attention max,” which condenses layers and heads and replaces the mean with a max function. This favors extreme positive signals appearing only in one or few layers and heads. In embodiments, the attention max approach computes a max among all the L layers and H attention heads as shown in Equation 2:

gₘₐₓ=maxₗ₌₁^{L}maxₕ₌₁^{H}A_{l,h} Equation 2

In embodiments, another approach to condense an attention tensor A is based on “rollout attention,” which propagates the information contained in an attention weight layer by layer from input to output, by multiplying the attention weights along multiple paths starting and ending to the same input-output pair. Since the attention head dimension is not modeled, embodiments condense that dimension via a sum. Which attention layer should be used in the end is not known, thus embodiments sum the newly computed rollout values of all the layers.

In embodiments, another approach to condense an attention tensor A is based on “follow-up attention.” Similar to the rollout attention, follow-up attention aggregates the attention weights over h attention heads by summing the weights of A along the attention head dimension and obtaining layer-wise attention L=Σₕ₌₁^{H}Aₕ. This condensed three-dimensional tensor is referred to as “layer-wise attention” represented by L. In embodiments, follow-up attention explicitly models the temporal relationship between the attention weights computed at different layers, since the attention weights in the later layers depend on the earlier ones. The inventors have recognized that the layer-after-layer transformation reflects the way in which the models explore code through time, similar to multiple successive fixations of a developer when navigating and exploring source code. Instead of looking at how a token gives attention to other tokens in the same layer, in embodiments follow-up attention adopts a differential approach which compares the attention received by token i at layer z with the attention received by token j at layer z−1. To represent this received attention, embodiments define a follower score fᵢ^{(z)} token i at layer z, as the vector of the attention quota that each other token gives to token i at the same layer. Similar to the self-attention vector, the follower score is also a vector of real numbers and it has the same length corresponding to the input sequence length, thus representing a complementary viewpoint. To realize the comparison between follower scores at two consecutive layers, embodiments use the cosine similarity as a soft version of the intersection between the set of followers of the two tokens. Embodiments then compute the follow-up attention for each ordered pair of tokens (i.e., i→j) and for each pair of consecutive layers, condense all layer pairs into a single matrix via sum. Embodiments aggregate attention over multiple layers, thus a generic embedding at position eᵢ in any layer l is traceable to the input embedding xᵢ in the input sequence.

These example postprocessing approaches have been identified as potentially useful, but the embodiments herein are not limited to use of these postprocessing approaches. Thus, other postprocessing approaches that generate mappings from an attention matrix are within the scope of the present disclosure.

In embodiments, mappings 119 represent a graph of relevance. That is, for each location in subject source code, mappings 119 associates a set of other relevant location(s) in the subject source code. A mapping could map a subject location in one source code file to relevant location(s) in the same source code file, and/or to relevant location(s) in other source code files processed together in the same LLM call. In some embodiments, location correspond to tokens (e.g., a chunk of characters, typically 2-6 characters) to which LLM observers have been assigned. However, other embodiments could translate tokens into some other location indicator (e.g., lines of source code).

The inventors have recognized that a given mapping (e.g., subject location to relevant location) may provide more valuable information to a developer if the locations in the mapping are further from each other. For example, a developer's eyes typically fall on nearby locations (e.g., lines surrounding a cursor location or selection) naturally, so pointing the developer to more distant but potentially relevant locations could provide more value to the developer than pointing the developer to these nearby locations. In embodiments, relevance generation component 112 uses a distance component 114 to weight each location in a set of relevant locations of a mapping, based on their distance from the subject location of the mapping. In some embodiments, using a base weighting for each relevant location (e.g., a base weighting of one), distance component 114 multiplies each relevant location of the mapping using a distance function. In one example, the distance function is the square root of a distance between that relevant location and the subject location to which it is mapped (e.g., in terms of tokens), though other distance functions could be used.

When two locations are in different source code files, distance component 114 can take a variety of approaches to determine a distance between those locations. Examples include summing a distance between the subject location and the end of its source code file with a distance of the relevant location from the beginning of its source code file, summing a distance of a relevant location from the beginning of its source code file with some fixed amount, and the like. In some embodiments, once distance component 114 has weighted each relevant location within a mapping, distance component 114 sorts the relevant locations within the mapping based on their weights (e.g., from highest to lowest weight). Additionally, or alternatively, in some embodiments, once distance component 114 has weighted each relevant location within a mapping, distance component 114 removes relevant location(s) having a weight that is below some threshold from the mapping.

Once neural relevance information (e.g., mappings 119) has been obtained from attention matrix 118 by relevance generation component 112, some embodiments bolster the information with static analysis. In embodiments, static analysis makes mappings 119 more interpretable to a human user. Thus, in FIG. 1, code editor 109 includes a relevance analysis component 115 that performs static analysis on one or more locations identified in mappings 119. In some embodiments, relevance analysis component 115 annotates or “colors” these locations within mappings 119 with indications as to how they are relevant to their subject location. In other embodiments, relevance analysis component 115 identifies relevance information on-demand based on operation of a code relevance UI component 111. For example, for a given mapping that maps a subject location to a set of relevant locations, relevance analysis component 115 may determine that a location in the set is relevant to the subject location as corresponding to relevant documentation, as containing a relevant assignment, as containing a relevant declaration (e.g., type, function, class), as being a relevant reference, and the like.

In embodiments, code relevance UI component 111 leverages mappings 119 to provide a code radar UI experience within code editor 109. In embodiments, code relevance UI component 111 comprises a UI element (e.g., pane, window, etc.) that provides relevant context for a code location that a user is currently focused on in an editor UI. In embodiments code relevance UI component 111 identifies a code location of interest (e.g., a code location corresponding to a cursor location within the editor UI, code that has been selected within the editor UI). Then, using relevance generation component 112, code relevance UI component 111 identifies relevant location(s) and presents those locations within the editor UI.

In embodiments, a code radar UI aims to provide a summary of relevant code locations that a user's eyes would naturally flow to, based on the code location that the user is currently focused on. For example, if a user is focused on a variable, the code radar UI may show a code location where the variable is declared, code location(s) where the variable is assigned, code location(s) where the variable is documented, and the like. In embodiments, the code radar UI provides one or more related code locations as sections of code (e.g., multiple lines, including context surrounding the code location of interest) as excerpts. In some embodiments, these excerpts emphasize more relevant portions, and deemphasize or even elide less relevant portions. In some embodiments, based on static analysis, the code radar UI also provides an indication of why a given code location may be relevant.

Code relevance UI component 111 therefore utilizes the attention mechanism of LLMs, possibly bolstered by static analysis, to guide source code navigation by displaying code location(s) determined to be relevant (e.g., most relevant) to a currently viewed and/or edited code location. In embodiments, code relevance UI component 111 summarizes relevant code locations on a radar screen UI, such as to the side of the currently viewed and/or edited code location. In embodiments, this radar screen contains an annotated and/or redacted view (e.g., with ellipses between the lines) of the whole document, or several documents, that changes as the user navigates through source code within code editor 109.

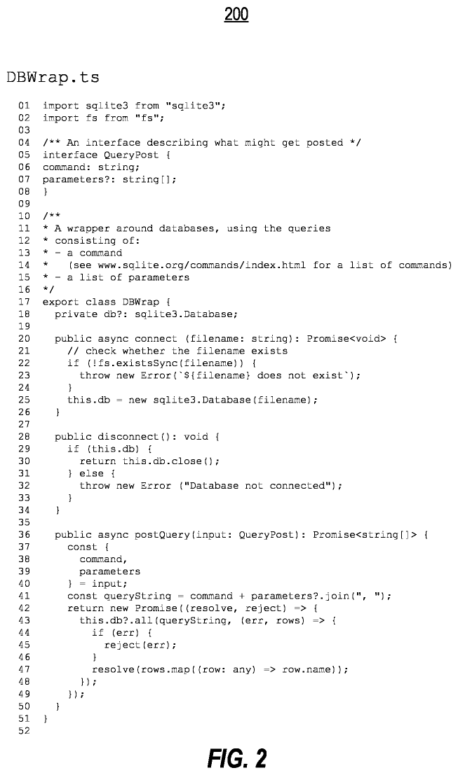

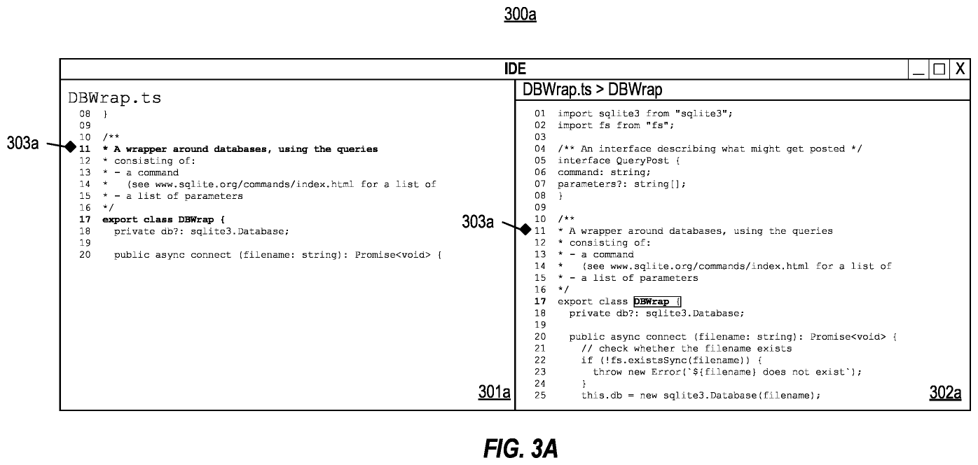

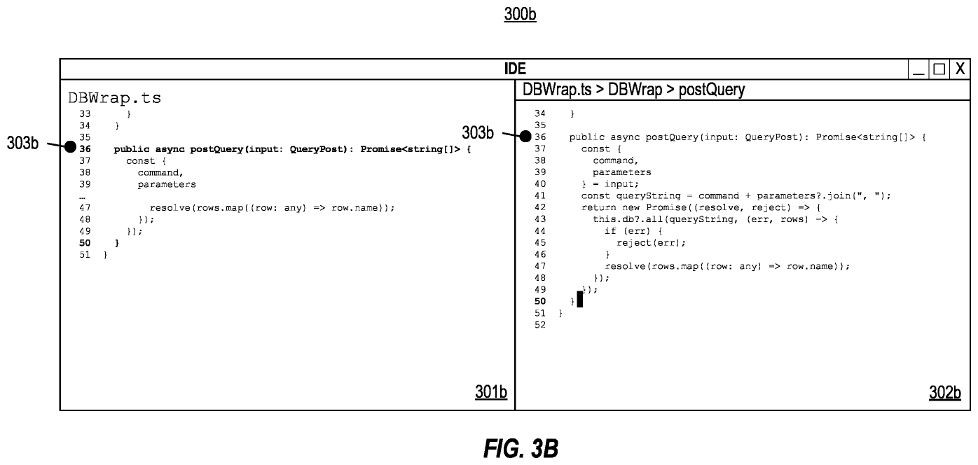

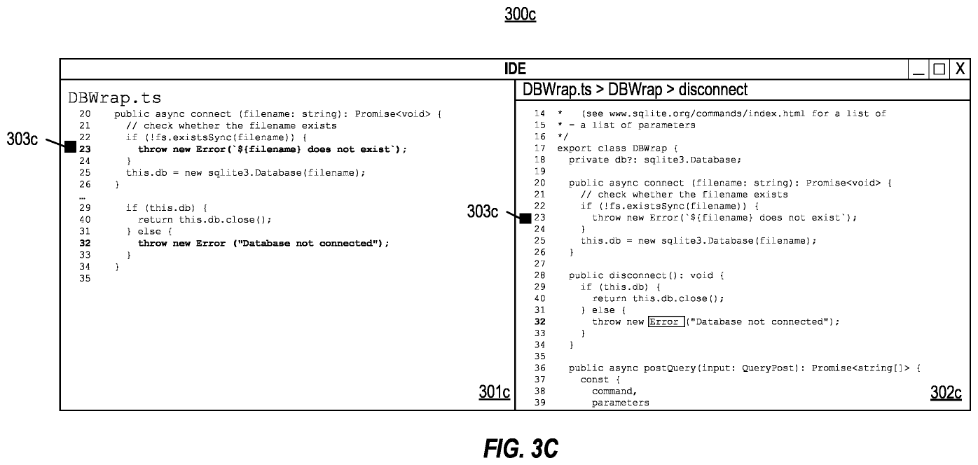

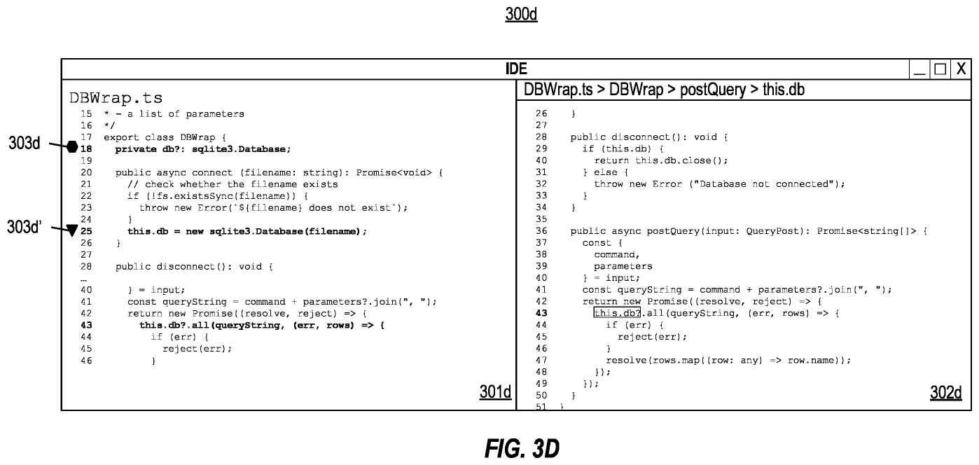

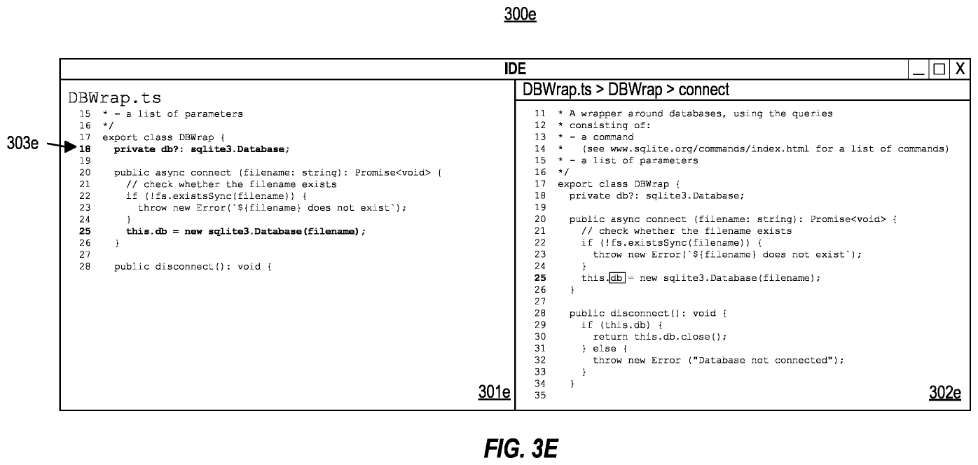

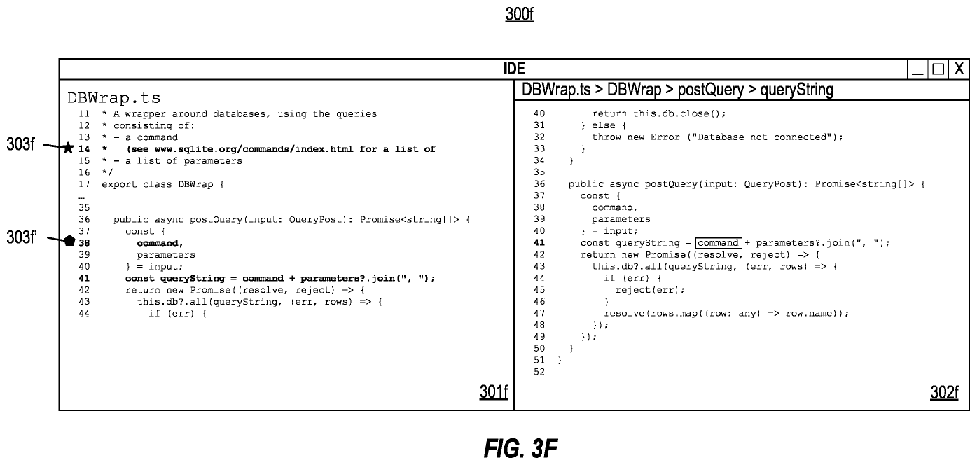

Examples of UI experiences, such as those that could be provided by code relevance UI component 111, are now described in connection with FIGS. 2 and 3A-3F. In particular, FIG. 2 illustrates a code sample 200, comprising a source code file (“DBWrap.ts”, e.g., part of source code 117) that is the subject of editing by code editor 109. FIGS. 3A-3F illustrate examples of a code radar UI using this code sample 200.

Referring to FIG. 3A, illustrated is an example of a UI 300a that includes an editor pane 302a and a code radar pane 301a. In editor pane 302a, a user has selected the class name “DBWrap” at line 17 of code sample 200. In response, code relevance UI component 111 has displayed, within code radar pane 301a, lines 08 to 20 of code sample 200. Within code radar pane 301a, line 11 is emphasized (e.g., as being a related location) and line 17 is also emphasized (e.g., as being the subject location). In code radar pane 301a, line 11 is associated with an indicator 303a, signaling why that line may be relevant (e.g., it corresponds to relevant documentation). Notably, because line 11 is also visible within editor pane 302a, code relevance UI component 111 also provides indicator 303a at line 11 within editor pane 302a.

Referring to FIG. 3B, illustrated is an example of a UI 300b that includes an editor pane 302b and a code radar pane 301b. In editor pane 302b, a cursor is located at line 50 of code sample 200. In response, code relevance UI component 111 has displayed, within code radar pane 301b lines 33 to 51 of code sample 200, with lines 40 to 46 being elided (e.g., as less relevant). Within code radar pane 301b, line 36 is emphasized (e.g., as being a related location). In code radar pane 301b, line 36 is associated with an indicator 303b, signaling why that line may be relevant (e.g., it relates to a syntactic start to the block that ends at line 50). Notably, because line 36 is also visible within editor pane 302b, code relevance UI component 111 also provides indicator 303b at line 36 within editor pane 302b.

Referring to FIG. 3C, illustrated is an example of a UI 300c that includes an editor pane 302c and a code radar pane 301c. In editor pane 302c, a user has selected “Error” at line 32 of code sample 200. In response, code relevance UI component 111 has displayed, within code radar pane 301c, lines 20 to 35 of code sample 200, with lines 27 to 28 being elided (e.g., as less relevant). Within code radar pane 301c, line 23 is emphasized (e.g., as being a related location) and line 32 is also emphasized (e.g., as being the subject location). In code radar pane 301c, line 23 is associated with an indicator 303c, signaling why that line may be relevant (e.g., it is an analogous situation). Notably, because line 23 is also visible within editor pane 302c, code relevance UI component 111 also provides indicator 303c at line 23 within editor pane 302c.

Referring to FIG. 3D, illustrated is an example of a UI 300d that includes an editor pane 302d and a code radar pane 301d. In editor pane 302d, a user has selected “this.db” at line 43 of code sample 200. In response, code relevance UI component 111 has displayed, within code radar pane 301d, lines 15 to 46 of code sample 200, with lines 29 to 39 being elided (e.g., as less relevant). Within code radar pane 301d, line 18 is emphasized (e.g., as being a related location) and line 43 is also emphasized (e.g., as being the subject location). In code radar pane 301d, line 18 is associated with an indicator 303d, signaling why that line may be relevant (e.g., as a relevant declaration). Additionally, in code radar pane 301f, line 25 is associated with an indicator 303d′, signaling why that line may be relevant (e.g., as a relevant assignment).

Referring to FIG. 3E, illustrated is an example of a UI 300e that includes an editor pane 302e and a code radar pane 301e. In editor pane 302e, a user has selected “db” at line 25 of code sample 200. In response, code relevance UI component 111 has displayed, within code radar pane 301e, lines 15 to 28 of code sample 200. Within code radar pane 301e, line 18 is emphasized (e.g., as being a related location) and line 25 is also emphasized (e.g., as being the subject location). In code radar pane 301e, line 18 is associated with an indicator 303e, signaling why that line may be relevant (e.g., as a relevant definition).

Referring to FIG. 3F, illustrated is an example of a UI 300f that includes an editor pane 302f and a code radar pane 301f. In editor pane 302f, a user has selected “command” at line 41 of code sample 200. In response, code relevance UI component 111 has displayed, within code radar pane 301f, lines 11 to 44 of code sample 200, with lines 18 to 34 being elided (e.g., as less relevant). Within code radar pane 301f, lines 14 and 38 are emphasized (e.g., as being related locations) and line 41 is also emphasized (e.g., as being the subject location). In code radar pane 301f, line 14 is associated with an indicator 303f, signaling why that line may be relevant (e.g., as a relevant documentation). Additionally, in code radar pane 301f, line 38 is associated with an indicator 303f′, signaling why that line may be relevant (e.g., it is another use of the variable).

In embodiments, code relevance UI component 111 provides a number of advantages over conventional code editors. For example, traditional IDEs have implemented “jump to definition”/“definition hovers” functionality, which displays the definition of a variable that a developer has hovered over, or a way to follow it on click. However, this functionality is only sometimes useful: often, definitions assign just a placeholder to a variable with the actually relevant assignment happening later. In embodiments, in addition to surfacing definitions, the radar screen experience provided by code relevance UI component 111 uses mappings 119 to surface best fitting documentation, syntactical fit (e.g. where does a multiline statement begin), most relevant assignment (most recent, or in the case of several execution paths the standard path), analogous pattern, the place where this is most critically used, and the like. Additionally, traditional IDEs have implemented “grep” (e.g., pattern search)/“highlight references” functionality. This functionality may contain more candidates than “jump to definition,” but still misses many candidates that could also be relevant. In embodiments, the radar screen experience provided by code relevance UI component 111 uses mappings 119 to provide a more complete list of candidates, using an intuitive UI experience.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

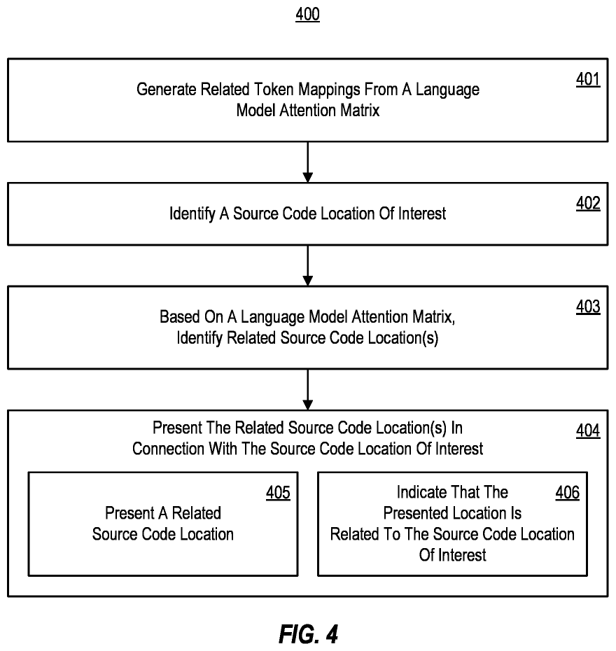

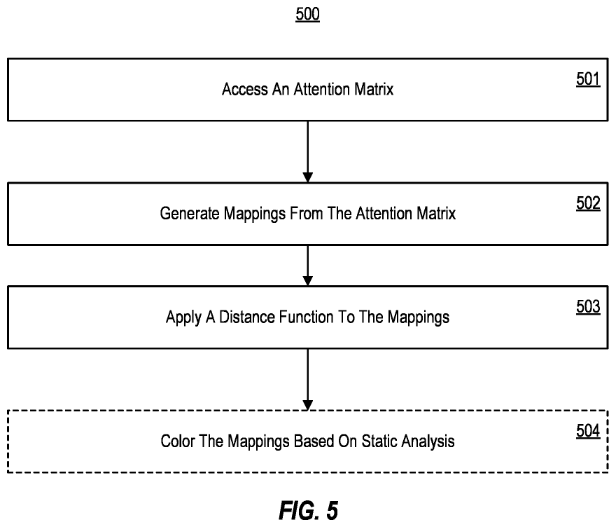

Embodiments are now described in connection with FIGS. 4 and 5, which illustrate a flow chart of example method 400 for providing a related source code navigation experience within a code editor UI, and a flow chart of example method 400 for generating a set of mappings of related source code locations based on a language model attention matrix. In embodiments, instructions for implementing method 400, 500 are encoded as computer-executable instructions (e.g., code relevance UI component 111, relevance generation component 112, and/or relevance analysis component 115) stored on a computer storage media (e.g., storage media 104) that are executable by a processor (e.g., processor 102) to cause a computer system (e.g., computer system 101) to perform method 400, 500.

Referring to FIG. 4, in embodiments, method 400 comprises an act 401 of generating related token mappings from a language model attention matrix. In some embodiments, act 401 comprises generating the set of mappings based on the language model attention matrix. In an example, relevance generation component 112 generates mappings 119 from attention matrix 118, which is generated as a result of operation of language model 116. Examples of act 401 are described in further detail infra in connection with method 500.

Method 400 also comprises an act 402 of identifying a source code location of interest (subject location). In some embodiments, act 402 comprises identifying a first source code location, the first source code location being within source code that is displayed at a code editor UI. In an example, code relevance UI component 111 identifies a current code location of interest from code being edited in code editor 109. In general, code relevance UI component 111 identifies the current location that a user is interacting with as a current code location of interest. As one example, this may be a selection (see, e.g., UI 300a, in which the location of interest is a selection on line 17 of code sample 200). Thus, in embodiments, the first source code location corresponds to a selection within the source code that is displayed within the code editor UI. As another example, this may be a cursor location (see, e.g., UI 300b, in which the location of interest is a cursor at line 50 of code sample 200). Thus, in embodiments, the first source code location corresponds to a cursor location within the source code that is displayed within the code editor UI.

Method 400 also comprises an act 403 of, based on a language model attention matrix, identifying related source code location(s). In some embodiments, act 403 comprises, from a set of mappings generated based on a language model attention matrix, identifying a set of one or more source code locations as being related to the first source code location, the set of one or more source code locations including a second source code location. In an example, code relevance UI component 111 uses mappings 119 to identify a set of one or more related code locations for the code location of interest identified in act 402. In one particular example, in UI 300a the location of interest is a selection on line 17 of code sample 200, and code relevance UI component 111 identifies line 11 of code sample 200. In another particular example, in UI 300b the location of interest is a cursor at line 50 of code sample 200, and code relevance UI component 111 identifies line 36 of code sample 200.

In embodiments, code relevance UI component 111 identifies related locations that are in the same source code file as the location of interest (e.g., as in the case of FIGS. 3A-3F). Thus, in embodiments, the first source code location and the second source code location are within a single source code file. Additionally, or alternatively, in embodiments, code relevance UI component 111 identifies related locations that are in different source code file(s) than the location of interest. Thus, in embodiments, the first source code location and the second source code location are in different source code files.

In embodiments, code relevance UI component 111 identifies a plurality of locations of interest. Thus, in some embodiments, act 403 comprises identifying a plurality of source code locations as being related to the first source code location, the plurality of source code locations including the second source code location. In some embodiments, a location of interest is identified from attention matrix 118. Thus, in embodiments, the plurality of source code locations includes at least one source code location identified based on the language model attention matrix. In some embodiments, a location of interest is identified based on static analysis by relevance analysis component 115. Thus, in embodiments, the plurality of source code locations includes at least one source code location identified based on based on static analysis.

Method 400 also comprises an act 404 of presenting the related source code location(s) in connection with the source code location of interest. In some embodiments, act 404 comprises, concurrent with presenting the first source code location in the code editor UI, presenting a related source code navigation experience. Examples of a related source code navigation experience were presented in connection with FIGS. 3A-3F.

As shown, act 404 includes an act 405 of presenting a related source code location, and an act 406 of indicating that the presented location is related to the source code location of interest. In embodiments, act 405 comprises presenting the second source code location in the code editor UI, while act 406 comprises presenting a visual indication that the second source code location is related to the first source code location. In one example, and in reference to UI 300a, code relevance UI component 111 displays an excerpt comprising lines 08 to 20 of code sample 200 within code radar pane 301a, and highlights line 11. Additionally, code relevance UI component 111 displays indicator 303a, indicating why line 11 is related to line 17. In another example, and in reference to UI 300b, code relevance UI component 111 displays an excerpt comprising lines 33 to 51 of code sample 200 within code radar pane 301b, and highlights line 36. Additionally, code relevance UI component 111 displays indicator 303b, indicating why line 36 is related to line 50.

In some embodiments, presenting the related source code navigation experience comprises presenting the second source code location within a first pane of the code editor UI that is separate from a second pane of the code editor UI within which the first source code location is displayed. For example, FIGS. 3A-3F, code relevance UI component 111 displayed related locations in a separate pane (code radar pane 301a-301f) than an editor pane (editor pane 302a-302f).

In some embodiments, presenting the related source code navigation experience comprises presenting the second source code location within the same pane of the code editor UI within which the first source code location is displayed. For example, in FIGS. 3A-3C, code relevance UI component 111 also displayed related locations in the editor pane (e.g., indicator 303a-303c within editor pane 302a-302c).

In some embodiments, presenting the second source code location in the code editor UI comprises: presenting a first source code line corresponding to the second source code location; and presenting a plurality of source code lines surrounding the first source code line as context for the first source code line. For example, in each of FIGS. 3A-3F, code relevance UI component 111 presented a plurality of source code lines around a related location.

In some embodiments, presenting the plurality of source code lines surrounding the first source code line as context for the first source code line comprises eliding one or more source code lines from a block of contiguous source code lines. For example, in FIG. 3B code relevance UI component 111 elided lines 40-46, in FIG. 3C code relevance UI component 111 elided lines 27-28, etc.

In some embodiments, presenting the visual indication that the second source code location is related to the first source code location comprises presenting an indication of why the second source code location is related to the first source code location. For example, the shape of each of indicator 303a-303f indicates that the indicator can provide an indication of why a source code location is related to another source code location. This can be communicated in different ways, including shape, color, hover-text, and the like. In embodiments, presenting the indication of why the second source code location is related to the first source code location is based on a static source code analysis (e.g., by relevance analysis component 115).

As mentioned, in embodiments, code relevance UI component 111 identifies a plurality of locations of interest, such that in act 403, the set of one or more source code locations includes a plurality of source code, the plurality of source code locations including the second source code location. In these embodiments, presenting the related source code navigation experience includes presenting each of the plurality of source code locations in the code editor UI, and for each of the plurality of source code locations, presenting a corresponding visual indication that the source code location is related to the first source code location. For example, FIGS. 3D and 3F each show two related source code locations.

As mentioned supra, examples of act 401 (generating related token mappings from a language model attention matrix) are described in further detail in connection with method 500. Referring to FIG. 5, method 500 comprises an act 501 of accessing an attention matrix. In some embodiments, act 501 comprises accessing an attention matrix that is produced as part of generation of a language model prediction. In an example, relevance generation component 112 accesses attention matrix 118, which was generated as part of operation of language model 116 in connection with editing source code 117 at code editor 109 (e.g., for generating completions for use by code completion component 110).

Method 500 also comprises an act 502 of generating mappings from the attention matrix. In some embodiments, act 502 comprises processing the attention matrix to generate a set of mappings, each mapping in the set of mappings associating a subject token within source code to a set of one or more related tokens within the source code, each related token being estimated to relate to the subject token. In an example, attention matrix analysis component 113 generates mappings 119 from attention matrix 118. Each mapping maps a token within source code 117 to a set of one or more other tokens that are estimated to be relevant to that token. Using an attention matrix to generate mappings 119 results in neural relevance information that is useful to, e.g., drive the code radar experience described herein.

As mentioned, in some embodiments attention matrix analysis component 113 generates mapping based, at least in part, on an attention mean postprocessing approach.

Thus, in embodiments, processing a language model attention matrix to generate the set of mappings includes attention mean postprocessing. As mentioned, in other embodiments attention matrix analysis component 113 generates mapping based, at least in part, on a follow-up attention postprocessing approach. Thus, in embodiments, processing a language model attention matrix to generate the set of mappings includes follow-up attention postprocessing.

Method 500 also comprises an act 503 of applying a distance function to the mappings. In some embodiments, act 503 comprises applying a distance function to one or more mappings in the set of mappings including, for a mapping of the one or more mappings, weighting each related token based on its distance from its subject token within the source code. In an example, distance component 114 weights each location in a set of relevant locations of a mapping, based on their distance from the subject location of the mapping. This enables code relevance UI component 111 to favor relevant locations that are further from a subject location, which may provide more valuable information to a developer than closer relevant locations. For example, a developer's eyes typically fall on nearby locations (e.g., lines surrounding a cursor location or selection) naturally, so pointing the developer to more distant but potentially relevant locations could provide more value to the developer than pointing the developer to these nearby locations.

In some embodiments, once distance component 114 has weighted each relevant location within a mapping, the distance component 114 sorts the relevant locations within the mapping based on their weights (e.g., from highest to lowest weight). Additionally, or alternatively, in some embodiments, once distance component 114 has weighted each relevant location within a mapping, the distance component 114 removes relevant location(s) having a weight that is below some threshold from the mapping.

In some embodiments, method 500 also comprises an act 504 of coloring the mappings based on static analysis. In some embodiments, act 504 comprises using a static analysis of the source code to generate an annotation for a related token, the annotation indicating why the related token is related to its subject token. In an example, relevance analysis component 115 that performs static analysis one or more locations identified in mappings 119. In some embodiments, relevance analysis component 115 annotates or “colors” these locations within mappings 119 with indications as to how they are relevant to their subject location. In other embodiments, relevance analysis component 115 identifies relevance information on-demand based on operation of a code relevance UI component 111. For example, for a given mapping that maps a subject location to a set of relevant locations, relevance analysis component 115 may determine that a location in the set is relevant to the subject location as corresponding to relevant documentation, as containing a relevant assignment, as containing a relevant declaration (e.g., type, function, class), as being a relevant reference, and the like.

In some embodiments, as part of its static analysis, relevance analysis component 115 identifies additional code locations that could be relevant, and adds them to a mapping. Thus, in some embodiments, method 500 further comprises using a static analysis of the source code to add a new related token to a mapping of the set of mappings.

Embodiments of the disclosure may comprise or utilize a special-purpose or general-purpose computer system (e.g., computer system 101) that includes computer hardware, such as, for example, a processor system (e.g., processor 102) and system memory (e.g., memory 103), as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 104). Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 105), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

It will be appreciated that the disclosed systems and methods may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments of the disclosure may also be practiced in distributed system environments where local and remote computer systems, which are linked (either by hardwired data links, wireless data links, or by a combination of hardwired and wireless data links) through a network, both perform tasks.

As such, in a distributed system environment, a computer system may include a plurality of constituent computer systems. In a distributed system environment, program modules may be located in both local and remote memory storage devices.

It will also be appreciated that the embodiments of the disclosure may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as, for example, Software as a Service (SaaS), Platform as a Service (PaaS), and Infrastructure as a Service (IaaS). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may be embodied in other specific forms without departing from its essential characteristics. The described embodiments are to be considered in all respects only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method, implemented at a computer system that includes a processor, comprising:
identifying a first source code location, the first source code location being within source code that is displayed at a code editor user interface (UI);
from a set of mappings generated based on a language model attention matrix, identifying a set of one or more source code locations as being related to the first source code location, the set of one or more source code locations including a second source code location; and
concurrent with presenting the first source code location in the code editor UI, presenting a related source code navigation experience, including:
presenting the second source code location in the code editor UI; and
presenting a visual indication that the second source code location is related to the first source code location.

2. The method of claim 1, wherein the first source code location corresponds to a cursor location within the source code that is displayed within the code editor UI.

3. The method of claim 1, wherein the first source code location corresponds to a selection within the source code that is displayed within the code editor UI.

4. The method of claim 1, wherein the first source code location and the second source code location are within a single source code file.

5. The method of claim 1, wherein the first source code location and the second source code location are in different source code files.

6. The method of claim 1, wherein the set of one or more source code locations includes a plurality of source code locations, the plurality of source code locations including the second source code location.

7. The method of claim 6, wherein presenting the related source code navigation experience includes:
presenting each of the plurality of source code locations in the code editor UI; and
for each of the plurality of source code locations, presenting a corresponding visual indication that the source code location is related to the first source code location.

8. The method of claim 6, plurality of source code locations includes at least one source code location identified based on the language model attention matrix, and at least one source code location identified based on static analysis.

9. The method of claim 1, wherein presenting the related source code navigation experience comprises presenting the second source code location within a first pane of the code editor UI that is separate from a second pane of the code editor UI within which the first source code location is displayed.

10. The method of claim 1, wherein presenting the related source code navigation experience comprises presenting the second source code location within a same pane of the code editor UI within which the first source code location is displayed.

11. The method of claim 1, wherein presenting the second source code location in the code editor UI comprises:
presenting a first source code line corresponding to the second source code location; and
presenting a plurality of source code lines surrounding the first source code line as context for the first source code line.

12. The method of claim 11, wherein presenting the plurality of source code lines surrounding the first source code line as context for the first source code line comprises eliding one or more source code lines from a block of contiguous source code lines.

13. The method of claim 1, wherein presenting the visual indication that the second source code location is related to the first source code location comprises presenting an indication of why the second source code location is related to the first source code location.

14. The method of claim 13, wherein presenting the indication of why the second source code location is related to the first source code location is based on a static source code analysis.

15. The method of claim 1, further comprising generating the set of mappings based on the language model attention matrix.

16. A method, implemented at a computer system that includes a processor, comprising:
accessing an attention matrix that is produced as part of generation of a language model prediction;
processing the attention matrix to generate a set of mappings, each mapping in the set of mappings associating a subject token within source code to a set of one or more related tokens within the source code, each related token being estimated to relate to the subject token; and
applying a distance function to one or more mappings in the set of mappings including, for a mapping of the one or more mappings, weighting each related token based on its distance from its subject token within the source code.

17. The method of claim 16, wherein processing a language model attention matrix to generate the set of mappings includes one or more of attention mean postprocessing or follow-up attention postprocessing.

18. The method of claim 16, further comprising using a static analysis of the source code to generate an annotation for a related token, the annotation indicating why the related token is related to its subject token.

19. The method of claim 16, further comprising using a static analysis of the source code to add a new related token to a mapping of the set of mappings.

20. A computer system comprising:
a processor; and
a computer storage media that stores computer-executable instructions that are executable by the processor to at least:
generate a set of mappings of related source code locations based on a language model attention matrix;
identify a first source code location, the first source code location being within source code that is displayed at a code editor user interface (UI);
from the set of mappings, identify a set of one or more source code locations as being related to the first source code location, the set of one or more source code locations including a second source code location; and
concurrent with presenting the first source code location in the code editor UI, present a related source code navigation experience, including:
presenting the second source code location in the code editor UI; and
presenting a visual indication that the second source code location is related to the first source code location.
